(19) United States
(12) Patent Application Publication
(10) Pub. No.: US 2024/0209943 A1
(43) Pub. Date: Jun. 27, 2024

(54) GASKET APPARATUS AND METHOD OF FORMING

(71) Applicant: SUB-DRILL SUPPLY LIMITED, Westhill Aberdeenshire (GB)

(72) Inventor: Mark D. PATON, Westhill Aberdeenshire (GB)

(21) Appl. No.: 18/288,528

(22) PCT Filed: Apr. 27, 2022
(86) PCT No.: PCT/GB2022/051063

§ 371 Date: Oct. 26, 2023

(30) Foreign Application Priority Data
Apr. 27, 2021 (GB) 2106015.7

(51) Int. Cl. F16J 15/08; E21B 33/03

(52) U.S. Cl. CPC F16J 15/0806; E21B 33/03

(57) ABSTRACT

The present invention concerns gasket apparatus comprising a substantially annular metallic element (1; 10) having an outwardly projecting rib (2; 12). The annular element has an inner concave profile and wherein outer surfaces (13, 14) of the annular element either side of the rib are angled or arcuate relative to the central axis of the annular element, to present sealing surfaces for engaging with tubular, wellhead or connector seat member surfaces. More particularly, where the outer surfaces of the annular element are angular, they are inclined at 22° to 23° to the annular element axis. Moreover, the surface finish on the inclined or arcuate outer sealing surfaces are Ra Micro Meter: 0.6/(Ra Micro Inch: 24) or finer. Further, the outer inclined or arcuate outer sealing surfaces have a metal based coating.

### BACKGROUND

The present invention relates to gasket apparatus and more particularly to metal gasket apparatus for use in metal to metal sealing connections between oil and gas well tubular members and other equipment in sub-sea drilling and production operations.

From EP3387313 it is known to provide metal gaskets having a generally annular configuration with a central outwardly projecting rib, the outer surfaces of the gasket either side of the central rib having inclined faces for engaging corresponding seats provided on respective ends of the tubular members being connected.

In order to be adopted within the industry, the gasket must satisfy certain standards, in particular it must achieve a successful qualification test in conformance with API 17D/ISO 13628-4 and API 6A/ISO 10423 PR-2 Including Annex F Qualification test to an API 6A/ISO 10423 Temperature Range U, X or Y (The U rating is −18° C. to +121° C./The X rating is −18° C. to +180° C./The Y rating is −18° C. to +345° C.) as a minimum in VX, VXVT, AX or CX profiles in wellheads, connectors, LMRP and Marine Risers or a non-standard temperature range between −18° C. and +345° C. Some Operators/Oil Companies have elaborated the above qualification test with longer pressure hold periods and more stringent acceptance criteria.

In this connection, most metal gaskets in this field operate on a plastic deformation basis, which has both advantages and disadvantages. In many cases, including that disclosed in EP3387313, such gaskets include secondary sealing elements in order to meet requirements, such as those of the above Qualification test.

An object of the present invention is to provide a metal gasket that operates on a substantially elastic deformation basis and which avoids the requirement of secondary sealing elements.

### SUMMARY OF INVENTION

According to the present invention there is provided gasket apparatus comprising a substantially annular metallic element having an outwardly projecting rib, wherein the annular element has an inner concave profile and wherein the outer surfaces of the annular element either side of the rib are angled or arcuate relative to the central axis of the annular element, to present sealing surfaces for engaging with corresponding tubular, wellhead or connector seat member surfaces;
wherein:—
i) in the case of angled outer surfaces, the outer sealing surfaces are inclined at 22° to 23° to the annular element axis; and
ii) the surface finish on the inclined or arcuate outer sealing surfaces are Ra Micro Meter: 0.6/(Ra Micro Inch: 24) or finer; and
iii) the outer inclined or arcuate outer sealing surfaces have a metal based coating.

Preferably, the outer sealing surfaces metal based coating is one of:—
i) a silver coating with a thickness of 10 to 20 micron (0.00045″ to 0.00078″); or
ii) WS2- a Tungsten based coating with a thickness of 0.5 micron (0.00002″)

With these conditions, the present invention relates to a gasket that will operate elastically, for example with AX, CX, VX/VT and VX Type seat preparations. In this respect, the Calculated Plastic Strain is 12% or less, over its entire operating conditions.

The present invention preferably relates to gasket apparatus products used in VX−VX/VT−AX and CX seat profiles that are machined into production and drilling equipment so that a gasket can be placed between the connecting members and pre-loaded via mechanical means and then provide an effective seal to the operating conditions for which it is designed.

Preferably, where the outer sealing surfaces are angled and inclined at 220 to 230 to the annular element axis, the apparatus is used with seating surfaces of seat profiles having angles between 22.75° and 23.25° to the annular element axis.

Preferably, the maximum calculated plastic strain is up to 12%.

Preferably, a wall of the annular element has a substantially scalloped profile in cross-section, with a concave profile or multi angled flats for the inner face and a convex or flat outer face from which the rib projects.

Preferably, the outer inclined or arcuate outer sealing surfaces have a silver coating with a thickness of 13-17 micron (0.00051″ to 0.00066″).

Another alternative may be WS2. This is a Tungsten based coating with very low coefficient of friction but is applied using compressed air that impinges a dry metallic coating usually in a thickness of 0.5 micron (0.00002″) Preferably, the gasket apparatus is used for sealing connected oil and gas tubulars, wellheads and connectors.

According to a further aspect of the invention there is provided a method of forming gasket apparatus, the gasket apparatus comprising a substantially annular metallic element having an outwardly projecting rib, wherein the annular element has an inner concave profile and wherein the outer surfaces of the annular element either side of the rib are angled or arcuate relative to the central axis of the annular element, to present sealing surfaces for engaging with tubular, wellhead or connector seat member surfaces;
the method comprising:—
i) forming the outer surfaces of the annular element, and in the case of angled outer surfaces, forming the outer sealing surfaces such that they are inclined at 220 to 230 to the annular element axis; and
ii) forming the surface finish on the inclined or arcuate outer sealing surfaces so that it is Ra Micro Meter: 0.6/(Ra Micro Inch: 24) or finer; and
iii) providing the outer inclined or arcuate outer sealing surfaces with a metal based coating.

Preferably, the outer sealing surfaces metal based coating is one of:—
i) a silver coating with a thickness of 10 to 20 micron (0.00045″ to 0.00078″); or
ii) WS2- a Tungsten based coating with a thickness of 0.5 micron (0.00002″)

### DETAILED DESCRIPTION

Embodiments of the present invention will now be described with reference to the accompanying drawings of which:—

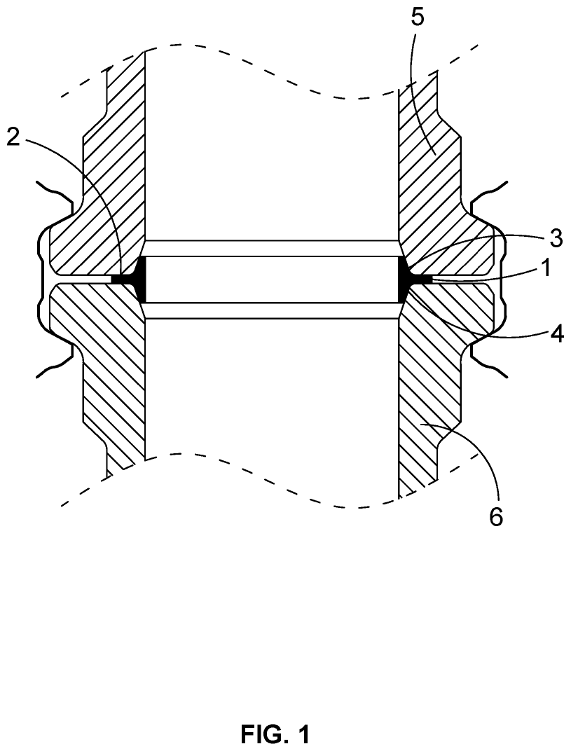

FIG. 1 shows a known gasket arrangement in situ between tubulars;

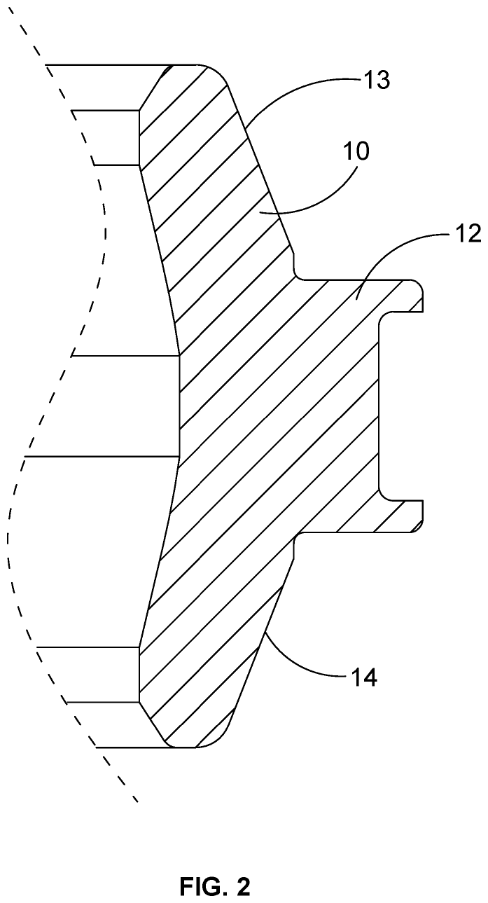

FIG. 2 shows a cross-sectional view through the wall of gasket apparatus according to a first embodiment;

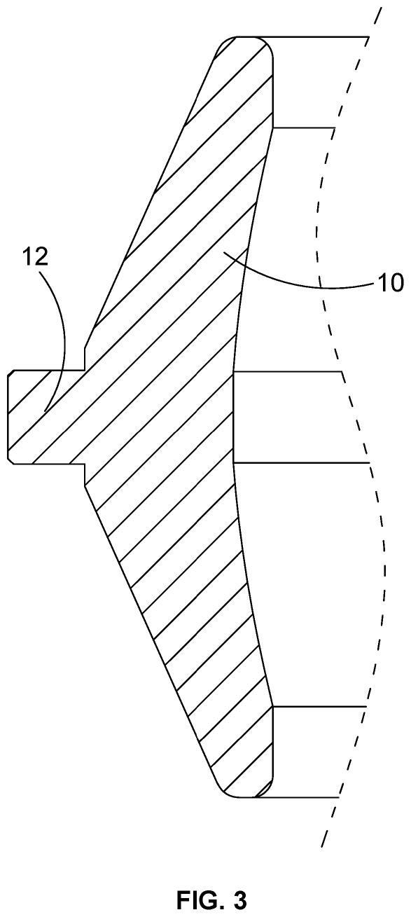

FIG. 3 shows a cross-sectional view through the wall of gasket apparatus according to a second embodiment;

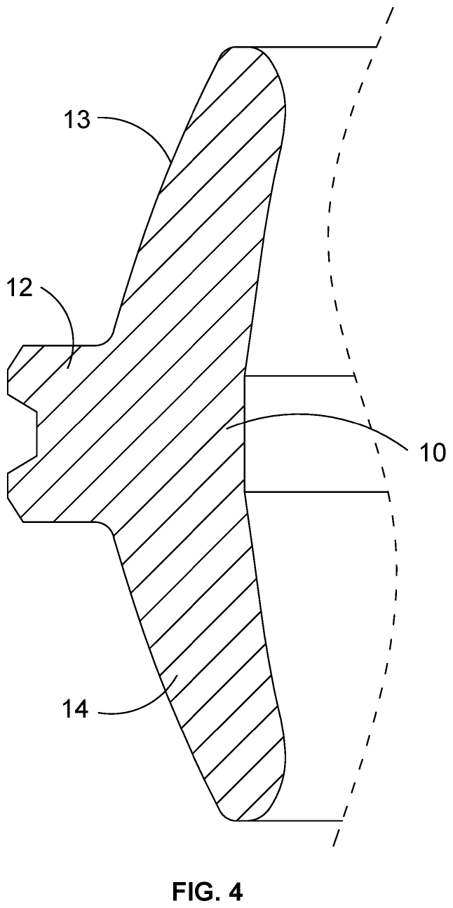

FIG. 4 shows a cross-sectional view through the wall of gasket apparatus according to a third embodiment; and

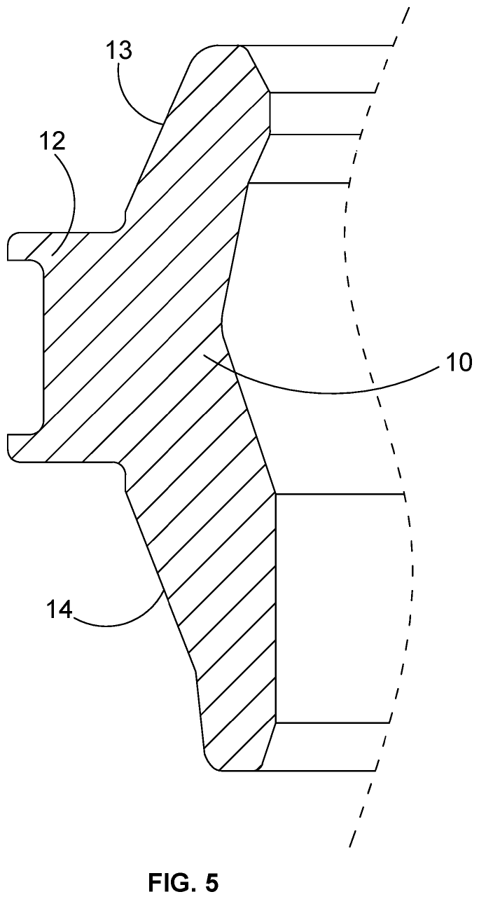

FIG. 5 shows a cross-sectional view through the wall of gasket apparatus according to a fourth embodiment.

As shown in FIG. 1, a known metal gasket arrangement comprises an annular configuration 1 with a central rib 2 projecting outwardly, the outer surfaces 3, 4 either side of the central rib having tapered or spherical faces for engaging seats provided on respective ends of the tubular members 5, 6 being connected.

Conventional metal gaskets of this nature generally operate on a plastic deformation basis, which has advantages and disadvantages. In many cases, such gaskets include secondary sealing elements in order to meet the requirements to pass the above Qualification test or meet their operational design requirements.

FIG. 2 shows a cross sectional view through a wall of gasket apparatus for use with an 18 3-4 VX type seat. As with the conventional gasket, the gasket arrangement comprises an annular configuration 10 with a central rib 12 projecting outwardly, the outer surfaces 13, 14 either side of the central rib having inclined or spherical faces relative to the central axis of the gasket, the inclined or spherical surfaces being configured for engaging seats provided on respective ends of the tubular members, wellhead members or connector being connected.

The seat profiles for such tubulars typically use angles between 22.750 and 23.25° over a varying length depending on the profile. With the present invention, the outer inclined surfaces 13, 14 are angled in a range of 22.00° to 23.00°.

In this connection, during the gasket design phase, the gasket sealing surface angle (or in the case of the embodiment of FIG. 4, the radius for the arcuate/spherical sealing surface) and amount of interference between the seat profile and gasket sealing surface must be engineered so that the contact stress is sufficient to maintain a seal over the gaskets full design conditions including temperature effects and external pressure.

If the plastic strain calculated during the gaskets engineering design is less than 12%, the gasket will maintain its contact stress over the entire range of design conditions during the qualification testing. If the gasket is not within this range it will not maintain sufficient contact stress to complete the qualification testing at the stated design conditions.

This is, as such, one of three separate aspects the applicant has identified as being involved in achieving success in qualification testing.

The second aspect relates to surface finish. In this connection, the applicants have established that a surface finish of—Ra (Average Roughness Grade) Micro Meter: 0.6/(Ra Micro Inch: 24) or finer on the gasket angled sealing surface or arcuate/spherical sealing surface is required.

In this connection, the surface finish must meet the above surface finish requirement or be finer on the gasket angled sealing surface or arcuate/spherical sealing surface for two reasons, one is to allow the sealing surface of the gasket in contact with the sealing surface on the seat profile to move without sticking during the preload of the gasket or while in service due to the roughness of the two faces in contact under high force.

The second reason is to maintain a gas tight seal. In this respect, it is specified in a number of international standards that 0.8/32 finish is required for gas tightness but the applicants have established that contrary to this international standard, a maximum Ra of 0.6/24 is required to ensure the gasket will remain gas tight during the entire qualification and does not gall or damage the seat profile during operation or pre-load.

The third aspect identified by the applicant in securing success in qualification testing relates to the specific parameters surrounding the provision of a metal based electroplated coating or metal based coating on the gasket sealing areas, to ensure the coating has a low co-efficient of friction to act as a solid, semi solid or powder based lubricant which maintains a metal to metal seal or metal to metal gas tight seal.

In this regard, whilst most known gasket products specify Grade C: Bright Silver plating with a thickness range of 7.62 to 12.7 micron (0.0003″ to 0.0005″), the applicants have departed from this established convention, evaluating that this thickness was not enough with their particular gasket design to complete the testing, and moreover, again against the face of established practice that the bright silver plating type was not ideal.

In this connection, there are four types of Silver Plating referenced in ASTM B700, namely:—
Grade A=Matt
Grade B=Bright
Grade C=Bright
Grade D=Semi-Bright

With the gasket apparatus of the present invention, it has been established that Grade D Semi Bright is the optimal type for achieving success in the qualification test, where provided with a thickness of 0.00045″ to 0.00078″ (10 to 20 micron).

The three aspects identified above are required to be met in order to achieve success in the qualification testing, specifically on pre-load and pressure cycles when the gasket is physically loaded by the closing of the connector or flanges and dynamic movement during endurance testing if the gasket seal area finish and silver plating is not as stated above, it will cause damage to the seats and not be gas tight due to galling that would be created without these conditions. if the plastic strain is more than 12% during any of the above parts of the qualification test, the gasket will not complete the qualification program as the plastic deformation will affect the contact stress and cause a gas or hydrostatic leak past the gasket.

Another important point is the combination of Plastic Strain/Seal Area surface finish and silver plating during testing when the gasket is subjected to its maximum and minimum temperature ratings in different ways with a gas testing medium. During the heat up and cooling down processes the gaskets essentially move dynamically as the materials expand or contract depending on high temp or low temp test and during this movement it is essential the surface finish and silver plating is correct as above or galling will occur due to expansion under the high temp rating and a gas leak will develop at that point or once the gasket or seats start to cool. The silver thickness and type is also important at this point since if the silver type and thickness are not correct it can be worn off during the gaskets dynamic movements at ambient/high or low test temperatures and if this occurs a gas leak will develop.

Whilst FIG. 2 shows a 18 3-4 VGX type gasket or application, FIG. 3 shows a cross sectional view through a wall of gasket apparatus for use with a 18 3-4 CX type seat according to the present invention and FIG. 4 shows a cross sectional view through a wall of gasket apparatus for use with a 18 3-4 AX type seat according to the present invention.

The scalloped shape of the bore of gasket apparatus allows it to move dynamically depending on the operating conditions/pressure that is applied to the gasket.

The VGT version of the gasket apparatus shown in the fourth embodiment of FIG. 5 is an emergency version that seals in a sealing face below the primary face when the primary sealing face is damaged.

It will be understood that the various aspects of the present invention can be practiced alone or in combination with one or more of the other aspects, as will be appreciated by those skilled in the relevant arts. The various aspects of the invention can optionally be provided in combination with one or more of the optional features of the other aspects of the invention. Also, optional features described in relation to one aspect can typically be combined alone or together with other features in different aspects of the invention. Any subject matter described in this specification can be combined with any other subject matter in the specification to form a novel combination.

Various aspects of the invention are described in detail with reference to the accompanying figures. Still other aspects, features, and advantages of the present invention are readily apparent from the entire description thereof, including the figures, which illustrates a number of exemplary aspects and implementations. The invention is also capable of other and different examples and aspects, and its several details can be modified in various respects, all without departing from the scope of the present invention. Accordingly, each example herein should be understood to have broad application, and is meant to illustrate one possible way of carrying out the invention, without intending to suggest that the scope of this disclosure, including the claims, is limited to that example. Furthermore, the terminology and phraseology used herein is solely used for descriptive purposes and should not be construed as limiting in scope. In particular, unless otherwise stated, dimensions and numerical values included herein are presented as examples illustrating one possible aspect of the claimed subject matter, without limiting the disclosure to the particular dimensions or values recited. All numerical values in this disclosure are understood as being modified by “about”. All singular forms of elements, or any other components described herein are understood to include plural forms thereof and vice versa.

Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Thus, throughout the specification and claims unless the context requires otherwise, the word “comprise” or variations thereof such as “comprises” or “comprising” will be understood to imply the inclusion of a stated integer or group of integers but not the exclusion of any other integer or group of integers.

Any discussion of documents, acts, materials, devices, articles and the like is included in the specification solely for the purpose of providing a context for the present invention. It is not suggested or represented that any or all of these matters formed part of the prior art base or were common general knowledge in the field relevant to the present invention.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including”, or “is” preceding the recitation of the composition, element or group of elements and vice versa. In this disclosure, the words “typically” or “optionally” are to be understood as being intended to indicate optional or non-essential features of the invention which are present in certain examples but which can be omitted in others without departing from the scope of the invention.

References to directional and positional descriptions such as upper and lower and directions e.g. “up”, “down” etc. are to be interpreted by a skilled reader in the context of the examples described to refer to the orientation of features shown in the drawings, and are not to be interpreted as limiting the invention to the literal interpretation of the term, but instead should be as understood by the skilled addressee.

Whilst the present invention has been described in relation to an oil and gas implementation, it will be understood that the gasket may be utilised in other appropriate environments.

1. A gasket apparatus comprising:
a substantially annular metallic element having an outwardly projecting rib, wherein the annular element has an inner concave profile and wherein the outer surfaces of the annular element either side of the rib are angled or arcuate relative to the central axis of the annular element, to present sealing surfaces for engaging with tubular, wellhead or connector seat member surfaces;
wherein:—
i) in the case of angled outer surfaces, the outer sealing surfaces are inclined at 22° to 23° to the annular element axis; and
ii) the surface finish on the inclined or arcuate outer sealing surfaces are Ra Micro Meter: 0.6/(Ra Micro Inch: 24) or finer; and
iii) the outer inclined or arcuate outer sealing surfaces have a metal based coating.

2. The gasket apparatus as claimed in claim 1, wherein the outer sealing surfaces metal based coating is one of:—
i) a silver coating with a thickness of 10 to 20 micron (0.00045″ to 0.00078″); or
ii) WS2- a Tungsten based coating with a thickness of 0.5 micron (0.00002″)

3. The gasket apparatus as claimed in claim 1, wherein where the outer sealing surface are angled and inclined at 22° to 230 to the annular element axis, the apparatus being used with seating surfaces of seat profiles having angles between 22.75° and 23.25° to the annular element axis.

4. The gasket apparatus as claimed in claim 1, wherein the maximum calculated plastic strain is up to 12%.

5. The gasket apparatus as claimed in claim 1, wherein a wall of the annular element has a substantially scalloped profile in cross-section, with a concave profile or multi angled flats for the inner face and a convex outer face or flat outer face from which the rib projects.

6. The gasket apparatus as claimed in in claim 1, wherein the outer inclined or spherical outer sealing surfaces have a silver coating with a thickness of 13-17 (0.00051″ to 0.00066″).

7. The gasket apparatus as claimed in claim 1, wherein the gasket apparatus is used for sealing connected oil and gas tubulars, wellheads or connectors.

8. A method of forming gasket apparatus, the gasket apparatus comprising a substantially annular metallic element having an outwardly projecting rib, wherein the annular element has an inner concave profile and wherein the outer surfaces of the annular element either side of the rib are angled or arcuate relative to the central axis of the annular element, to present sealing surfaces for engaging with tubular, wellhead or connector seat member surfaces;
the method comprising:—
i) forming the outer surfaces of the annular element and in the case of angled outer surfaces, forming the outer sealing surfaces such that they are inclined at 22° to 23° to the annular element axis; and
ii) forming the surface finish on the inclined or arcuate outer sealing surfaces so that it is Ra Micro Meter: 0.6/(Ra Micro Inch: 24) or finer; and
iii) providing the outer inclined or arcuate outer sealing surfaces with a metal based coating.

9. The method of claim 8, wherein the outer sealing surfaces metal based coating is one of:—
i) a silver coating with a thickness of 10 to 20 micron (0.00045″ to 0.00078″); or
ii) WS2- a Tungsten based coating with a thickness of 0.5 micron (0.00002″).
